(19) United States
(12) Patent Application Publication
(10) Pub. No.: US 2026/0212429 A1
(43) Pub. Date: Jul. 23, 2026

(54) METHOD FOR CONTROLLING WATER USAGE, COMPUTER DEVICE, AND STORAGE MEDIUM

(71) Applicant: HON HAI PRECISION INDUSTRY CO., LTD., New Taipei (TW)

(72) Inventors: Chin-Pin KUO, New Taipei (TW); Chih-Te LU, New Taipei (TW); Tsung-Wei LIU, New Taipei (TW)

(21) Appl. No.: 19/243,791

(22) Filed: Jun. 20, 2025

(30) Foreign Application Priority Data
Jan. 23, 2025 (CN) 202510111567.4

(51) Int. Cl. G06Q 50/06

(52) U.S. Cl. CPC G06Q 50/06

(57) ABSTRACT

This application provides a method for controlling water usage, a computer device, and a storage medium. The method includes collecting real-time water usage information corresponding to a target scenario. A historical water usage mode corresponding to the target scenario is determined. A water usage status corresponding to the target scenario is determined based on real-time water usage information and the historical water usage mode. Once target environment information corresponding to the target scenario is determined when the water usage status is an abnormal water usage, a water usage strategy corresponding to the target scenario is determined based on the target environment information.

### TECHNICAL FIELD

This application belongs to a technical field of water resource management, and particularly relates to a method for controlling water usage, a computer device, and a storage medium.

### BACKGROUND TECHNIQUE

Modern cities are facing increasingly severe water resource shortages, and water waste in buildings has become a significant challenge. Therefore, it is necessary to implement effective water usage management in buildings.

In related technologies, most water usage in buildings is monitored manually. However, this method cannot monitor water usage in real-time, is not able to respond promptly to abnormal water usage, and easily leads to a waste of water resource.

### BRIEF DESCRIPTION OF THE DRAWINGS

FIG. 1 is a schematic diagram of an application scenario of a method for controlling water usage provided in this application;

FIG. 2 is a flowchart of the method for controlling water usage provided in this application;

FIG. 3 is a flowchart of a method for determining an abnormal source provided in this application;

FIG. 4 is a structural diagram of a water usage control apparatus provided in this application;

FIG. 5 is a structural diagram of a computer device provided in this application.

### DETAILED DESCRIPTION

The following describes the embodiments of the present application in detail. Examples of the embodiments are illustrated in the accompanying drawings, where the same or similar reference numerals throughout denote the same or similar elements or elements with the same or similar functions. The embodiments described below with reference to the accompanying drawings are exemplary and are intended to explain the present application, but should not be construed as limiting the present application.

In the description of the present application, it should be noted that the term “a plurality of” means two or more, unless otherwise specifically defined. The terms “installed,” “connected,” and “coupled” should be understood broadly. For example, they may refer to fixed connections, detachable connections, or integral connections; they may also refer to mechanical connections, electrical connections, or communication connections; they may refer to direct connections or indirect connections through an intermediary, and they may refer to internal connections between two elements or interaction relationships between two elements. For those of ordinary skill in the art, the specific meanings of the above terms in the present application can be understood according to specific circumstances.

The following will describe some embodiments of the present application in detail with reference to the accompanying drawings.

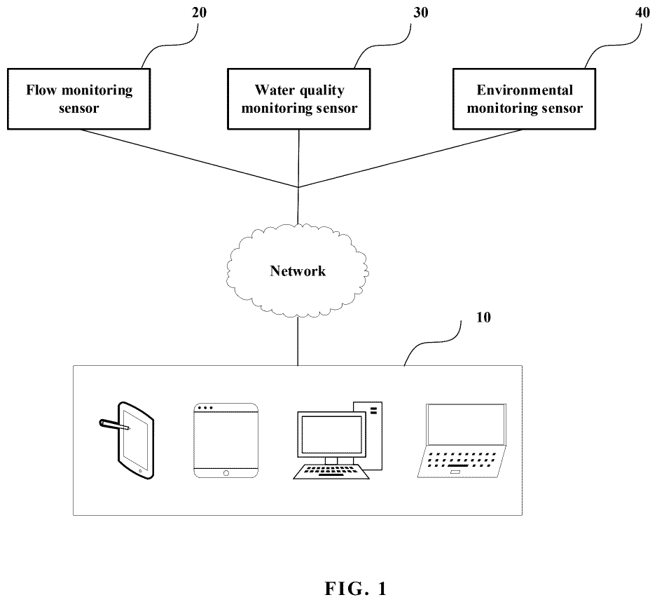

Please refer to FIG. 1, which is an application scenario diagram of a method for controlling water usage provided by an embodiment of the present application. The application scenario includes a computer device 10, one or more flow monitoring sensors 20, one or more water quality monitoring sensors 30, and one or more environmental monitoring sensors 40. The one or more flow monitoring sensors 20, the one or more water quality monitoring sensors 30, and the one or more environmental monitoring sensors 40 are connected to the computer device 10 via a network. The network serves as a medium for providing communication links between the one or more flow monitoring sensors 20 and the computer device 10, the one or more water quality monitoring sensors 30 and the computer device 10, and the one or more environmental monitoring sensors 40 and the computer device 10. The network may include various types of connections, such as wired communication links, wireless communication links, etc., without limitation.

In some embodiments, the computer device 10 may represent a device with data processing capabilities. The computer device 10 includes, but is not limited to, any electronic product that can interact with users through a keyboard, a mouse, a remote control, a touchpad, or a voice control device, such as a personal computer, a tablet, a smartphone, etc.

In some embodiments, the flow monitoring sensor 20 is installed in a water pipe of a building to monitor an amount of water (the amount of water can be referred to as “water flow” for ease of description) used in the water pipe. The flow monitoring sensor 20 may include an ultrasonic flow meter, a millimeter-wave radar flow meter, and/or a photoelectric flow meter. The embodiment of the present application monitors the water flow in the water pipe through the flow monitoring sensor 20 and analyzes the water flow through the computer device 10 to manage the water usage of the building, thereby avoiding water waste.

In some embodiments, the water quality monitoring sensor 30 is installed in the water pipe of the building to monitor water quality parameters of the water in the pipes. The water quality parameters may include a pH value, a dissolved oxygen content, a turbidity, and/or a conductivity. The water quality monitoring sensor 30 may include a pH sensor, a dissolved oxygen sensor, a turbidity sensor, a conductivity sensor, or any combination thereof. The embodiment of the present application monitors the water quality parameters in the water pipe through the water quality monitoring sensor 30 and analyzes the water quality parameters through a computer device 10 to manage a water quality of the building, promptly identify and address water quality issues, and ensure a water safety.

In some embodiments, the environmental monitoring sensor 40 is used to monitor environment information related to water usage. The environment information may include temperature information, humidity information, and rainfall information. The environmental monitoring sensor 40 may include a temperature sensor, a humidity sensor, a precipitation sensor, or any combination thereof. The embodiment of the present application collects the environment information related to water usage through the environmental monitoring sensor 40 and analyzes the environment information through the computer device 10 to predict a water demand of the building, thereby formulating a reasonable water usage strategy, improving an accuracy of controlling the water usage, and avoiding waste of the water resource.

In some embodiments, the flow monitoring sensor 20 sends the water flow in the water pipe to the computer device 10, the water quality monitoring sensor 30 sends the water quality parameters in the water pipe to the computer device 10, and the environmental monitoring sensor 40 sends the environment information to the computer device 10. The computer device 10 analyzes the water flow, the water quality parameters, and the environment information to achieve a management of the water resource. The computer device 10 includes a display (not shown in the figure), which can display the water flow, the water quality parameters, the environment information, and management information related to the water resource (e.g., a water usage status, a water usage strategy, etc.). The above information can be displayed through visual tools such as charts and reports, without limitation.

In the application scenario provided by the embodiment of the present application, the water flow in the water pipe is monitored through the flow monitoring sensor 20, and the water flow is analyzed through the computer device 10 to manage the water usage of the building, thereby avoiding water waste. The water quality parameters in the water pipe are monitored through the water quality monitoring sensor 30, and the water quality parameters are analyzed through the computer device 10 to manage the water quality of the building, water quality issues can be promptly identified and addressed, and water safety is ensured. The environment information related to water usage is collected through the environmental monitoring sensor 40, and the environment information is analyzed through the computer device 10 to predict the water demand of the building, thereby formulating the reasonable water usage strategy, improving the accuracy of water usage control, and avoiding water resource waste.

FIG. 1 is merely an example of the application scenario and does not limit the application scenario. The application scenario may include more or fewer devices than shown, or combine certain components, or use different components. For example, the computer device 10 may also include input/output devices, network access devices, etc.

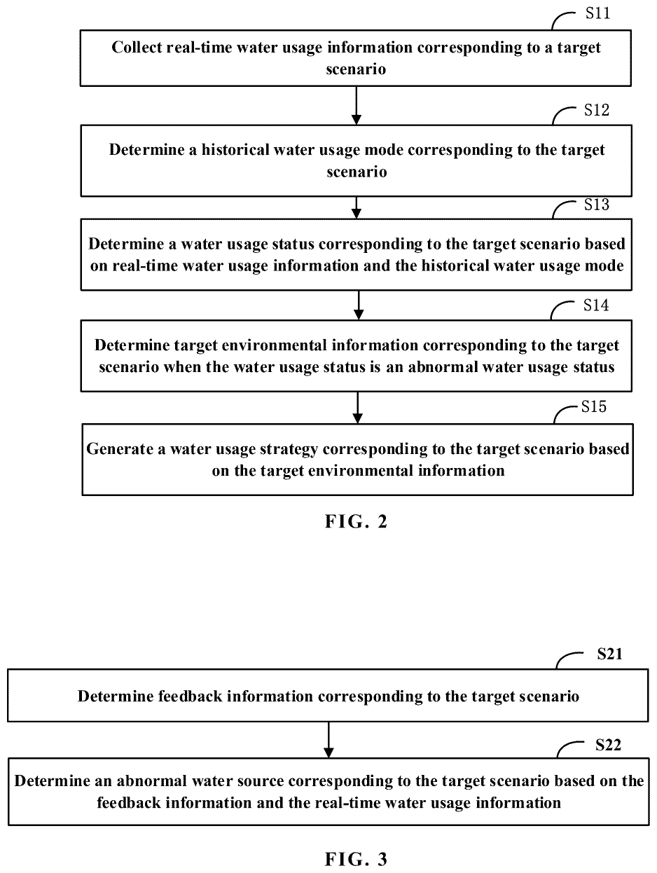

FIG. 2 is a flowchart of a method for controlling water usage provided by an embodiment of the present application. The method for controlling water usage is applied to a computer device (e.g., the computer device 10 in FIG. 1). The method for controlling water usage includes the following steps:
S11, real-time water usage information corresponding to a target scenario is collected.

In at least one embodiment of the present application, the target scenario is a water usage scenario. For example, the target scenario may include a building water usage scenario, a public service water usage scenario, and a production operation water usage scenario, among others. The embodiment of the present application uses the building water usage scenario as an example for explanation.

In some embodiments, the target scenario includes a plurality of water pipes, and the real-time water usage information is used to indicate the real-time water usage of each of the plurality of water pipes in the target scenario. In some embodiments, collecting the real-time water usage information corresponding to the target scenario includes: collecting water flow and water quality parameters of each water pipe in the target scenario; and determining the water flow and the water quality parameters as the real-time water usage information. The water flow can be obtained by monitoring the water pipe through the flow monitoring sensor, and the water quality parameters can be obtained by monitoring the water pipe through the water quality monitoring sensor. The water quality parameters may include the pH value, the dissolved oxygen content, the turbidity, and the conductivity, among others.

In some embodiments, considering that the water flow monitored by the flow monitoring sensor and the water quality parameters monitored by the water quality monitoring sensor may have noise or erroneous data, after collecting the real-time water usage information corresponding to the target scenario, the method further includes: preprocessing the real-time water usage information. The preprocessing may include data cleaning and denoising. By preprocessing the real-time water usage information, noise or erroneous data in the real-time water usage information can be removed, ensuring the quality and consistency of the real-time water usage information and improving the accuracy of water usage analysis.
S12, a historical water usage mode corresponding to the target scenario is determined.

In at least one embodiment of the present application, the historical water usage mode is used to represent fluctuation information and historical water quality information of water usage obtained by analyzing historical water usage information. Determining the historical water usage mode corresponding to the target scenario includes: obtaining the historical water usage information corresponding to the target scenario; determining the fluctuation information and historical water quality information of water usage corresponding to the target scenario based on the historical water usage information; and determining the historical water usage mode based on the fluctuation information and the historical water quality information.

The historical water usage information may include historical water flow and historical water quality parameters. The historical water flow can be obtained by monitoring the water flow in the water pipe of the target scenario (e.g., the building) over a period of time through the flow monitoring sensor. The historical water quality parameters can be obtained by monitoring the water quality in the water pipe of the target scenario (e.g., the building) over the period of time through the water quality monitoring sensor. The fluctuation information may include changes in water usage in different seasons and changes in water usage during the day and the night. Accordingly, the historical water usage mode may include water usage peaks and troughs in different seasons and water usage peaks and troughs during the day and night. The historical water quality parameters may include the pH value, the dissolved oxygen content, the turbidity, and the conductivity, among others. By processing the historical water quality parameters using a preset function, the historical water quality information can be obtained. The preset function may include a mean function, a median function, etc., which is not limited. For example, by averaging multiple pH values, an average pH value can be obtained. By averaging multiple dissolved oxygen contents, an average dissolved oxygen content can be obtained. Accordingly, the historical water usage mode also includes the historical water quality information corresponding to the historical water quality parameters.

In some embodiments, a model for determining the water usage mode can be pre-trained. Input data of the model is historical water flow and historical water quality parameters, and output data of the model is the historical water usage mode. The model may be a neural network model, and a training method may include a supervised learning or an unsupervised learning, which is not limited here.
S13, a water usage status corresponding to the target scenario is determined based on real-time water usage information and the historical water usage mode.

In at least one embodiment of the present application, the water usage status may include an abnormal water usage status and a normal water usage status. The abnormal water usage status indicates abnormal water flow and/or abnormal water quality parameters, while the normal water usage status indicates normal water flow and normal water quality parameters. By comparing the real-time water usage information with the historical water usage mode, the water usage status of the target scenario can be determined.

In some embodiments, determining the water usage status corresponding to the target scenario based on the real-time water usage information and the historical water usage mode includes: determining the water usage status corresponding to the target scenario based on the real-time water usage information and the historical water usage mode using a preset detection model; or determining outlier information in the real-time water usage information based on the real-time water usage information and the historical water usage mode, and determining the water usage status corresponding to the target scenario based on the outlier information; or predicting a water usage based on the historical water usage mode using a preset water usage prediction mode; determining a water usage difference between the predicted water usage and a water usage corresponding to the real-time water usage information; and determining the water usage status corresponding to the target scenario based on the water usage difference.

In some embodiments, the detection model is used to detect the water usage status of the target scenario. The input data of the detection model may include the real-time water usage information and the historical water usage mode, and the output data includes the water usage status. The detection model may be a neural network model, and the training method may include a supervised learning and an unsupervised learning. A specific process of the supervised learning and the unsupervised learning can be referred to in related technologies, and will not be repeated here.

In some embodiments, the historical water usage mode is used as a baseline mode when the target scenario in the normal water usage status, and data points in the real-time water usage information that deviate from the baseline mode are considered outliers. The outlier information includes a number of outliers and aggregation information. By analyzing the number of outliers and the aggregation information, the water usage status corresponding to the target scenario can be determined. For example, if the number of outliers is greater than or equal to a preset threshold, and the aggregation information meets a preset aggregation condition, the abnormal water usage status is determined; if the number of outliers is less than the preset threshold, and/or the aggregation information does not meet the preset aggregation condition, the normal water usage status is determined. The preset threshold can be set according to actual needs. The aggregation information describes a degree of aggregation of the outliers, and the preset aggregation condition can be set according to actual needs. For example, the preset aggregation condition may include that three outliers are continuous occurred.

In some embodiments, the water usage prediction model may be a long short-term memory (LSTM) model, which is used to establish a time series model of water usage based on the historical water usage mode. Through the water usage prediction model, the predicted water usage of the target scenario can be predicted (referred to as “predicted water usage” for ease of description). By comparing the predicted water usage with the water usage in the real-time water usage information, the water usage difference can be determined. If the water usage difference is greater than or equal to the preset water usage threshold, the water usage status is determined to be abnormal; if the water usage difference is less than the preset water usage threshold, the water usage status is determined to be normal. The preset water usage threshold can be set according to actual needs, without limitation.

In other embodiments, for the water quality parameters, a normal parameter range can be preset for each water quality parameter. If the monitored water quality parameter is within the normal parameter range, the water quality is determined to be normal; if the monitored water quality parameter is not within the normal parameter range, the water quality is determined to be abnormal. The normal parameter range can be set according to actual needs, without limitation.
S14, when the water usage status is the abnormal water usage status, target environment information corresponding to the target scenario is determined.

In at least one embodiment of the present application, when the water usage status is the normal water usage status, steps S11 to S13 are executed until the water usage status is changed to be the abnormal water usage status. When the water usage status is the abnormal water usage status, the target environment information corresponding to the target scenario is determined. In some embodiments, determining the target environment information corresponding to the target scenario includes: obtaining the temperature information, the humidity information, and the rainfall information corresponding to the target scenario; and determining that the target environment information includes the temperature information, the humidity information, and the rainfall information. The temperature information, the humidity information, and the rainfall information can be obtained through the environmental monitoring sensor.

In some embodiments, when the water usage status is the abnormal water usage status, the method further includes: determining the flow monitoring sensor corresponding to the abnormal water usage as a target flow monitoring sensor; determining a water pipe corresponding to the target flow monitoring sensor as an abnormal water pipe according to a preset correspondence between the target flow monitoring sensor and the abnormal water pipe; and determining an area where the abnormal water pipe is located as a water usage abnormal area of the target scenario. By analyzing the real-time water usage information, when the water usage status is the abnormal water usage status, the flow monitoring sensor that detected the abnormal water usage can be determined. By analyzing the real-time water usage information and according to the correspondence between the flow monitoring sensor and the water pipe, the water usage abnormal area can be determined, enabling timely water usage management of an abnormal area and improving an effectiveness of water usage management in the target scenario.
S15, a water usage strategy corresponding to the target scenario is generated based on the target environment information.

In some embodiments, the water usage strategy may include water usage time and a water usage. Based on the target environment information, the water usage time and the water usage are controlled to achieve a multi-dimensional water usage control and improve an accuracy of controlling water usage.

In some embodiments, generating the water usage strategy corresponding to the target scenario based on the target environment information includes: determining the water usage time based on the temperature information; determining an target water usage based on the humidity information and the rainfall information; and generating the water usage strategy based on the water usage time and the target water usage.

In some embodiments, a preferred temperature range for the water usage time can be preset. If the monitored temperature information is within the preferred temperature range, usage of water is enabled; if the monitored temperature information is not within the preferred temperature range, usage of water is suspended. For example, a green space of a community is usually irrigated during the day. However, when the temperature in the summer is high, a evaporation rate is high, which leads to a reduced water usage efficiency. Based on this, the water usage strategy may include adjusting the irrigation time to early morning or evening. It is because that the irrigation during a cooler time with a lower evaporation rate can reduce a water loss and improve water resource utilization efficiency.

In some embodiments, a reasonable water usage (referred to as “target water usage” for ease of description) can be determined by combining the humidity information and rainfall the information. For example, when irrigating a landscape green space, an irrigation demand can be determined by combining the humidity information of soil and the rainfall information, avoiding an unnecessary irrigation when the soil is already at a suitable humidity level or when rainfall is forecasted, thereby reducing water resource waste.

Another example is that manual faucets in office building restrooms are often left on by employees, leading to waste. Based on this, the water usage strategy may include replacing manual faucets with automatic sensor faucets, which only turn on when a hand is detected and automatically turn off after use, reducing waste.

Another example is installing dual-flush water-saving toilets in restrooms, allowing users to choose between a large or small flush based on need, thereby reducing unnecessary water waste.

Another example is that traditional sprinkler systems used for irrigating landscape green spaces outside office buildings often result in significant water evaporation during midday in the summer, leading to water waste. Based on this, the water usage strategy may include replacing traditional sprinkler systems with drip irrigation systems, which reduce evaporation and ensure water is delivered directly to plant roots, thereby improving irrigation efficiency.

In some embodiments, after determining the water usage strategy corresponding to the target scenario, the method further includes: collecting updated real-time water usage information corresponding to the target scenario; determining the water usage status corresponding to the target scenario based on the updated real-time water usage information and the historical water usage mode; and outputting an alert when the water usage status is the abnormal water usage status, prompting relevant personnel to inspect and replace water usage equipment in a timely manner. The alert can be sent via a SMS, an email, an app push notification, etc., without limitation. By monitoring the real-time water usage information after implementing the water usage strategy, the embodiment of the present application can detect whether the abnormal water usage status is due to faulty water usage equipment and output an alert when the water usage equipment is faulty, enabling relevant personnel in the target scenario to receive a real-time feedback on water usage, promoting a rational use and management of water resources, and achieving sustainable development of water resources.

The method for controlling water usage provided by the embodiment of the present application can promptly monitor whether there is abnormal water usage in the target scenario based on real-time water usage information and the historical water usage mode, improving a timeliness of abnormal water usage response. Moreover, the method can determine the target environment information of the target scenario when the abnormal water usage is detected and use the target environment information to generate the water usage strategy, improving the accuracy of water usage strategy determination and avoiding water resource waste.

In at least one embodiment of the present application, the abnormal source corresponding to the target scenario can be determined by combining user feedback information. FIG. 3 is a flowchart of a method for determining an abnormal source provided by an embodiment of the present application. The method for determining the abnormal source is applied to a computer device. As shown in FIG. 3, the method includes the following steps:
S21, feedback information corresponding to the target scenario is determined.

In at least one embodiment of the present application, the feedback information may represent a feedback on water usage, and the feedback information may include a water quality feedback type and a flow feedback type. For example, the feedback information may include information such as a water pressure problem, a water odor, and a water color change. Among them, the water pressure problem belongs to the flow feedback type, and the water odor and the water color change belong to the water quality feedback type.
S22, an abnormal water source corresponding to the target scenario is determined based on the feedback information and the real-time water usage information.

In at least one embodiment of the present application, if the feedback information is the water quality feedback type, the water quality parameters in the real-time water usage information are analyzed to quickly determine that the abnormal water source corresponding to the target scenario is abnormal water quality. If the feedback information is the flow feedback type, the water flow in the real-time water usage information is analyzed to quickly determine the abnormal water source corresponding to the target scenario. The abnormal water source represents a cause of abnormal water usage in the target scenario. The abnormal water source may include abnormal water quality, water pipe leakage, water pipe blockage, etc. Following the above example, if the feedback information is the water pressure problem, by correlating the water pressure issue with water usage, it can be determined whether there is a water pipe leakage or blockage, thereby determining the abnormal water source. By correlating the feedback information with the real-time water usage information, the embodiment of the present application can quickly and accurately determine the abnormal source corresponding to the target scenario, improving the timeliness and accuracy of water usage control.

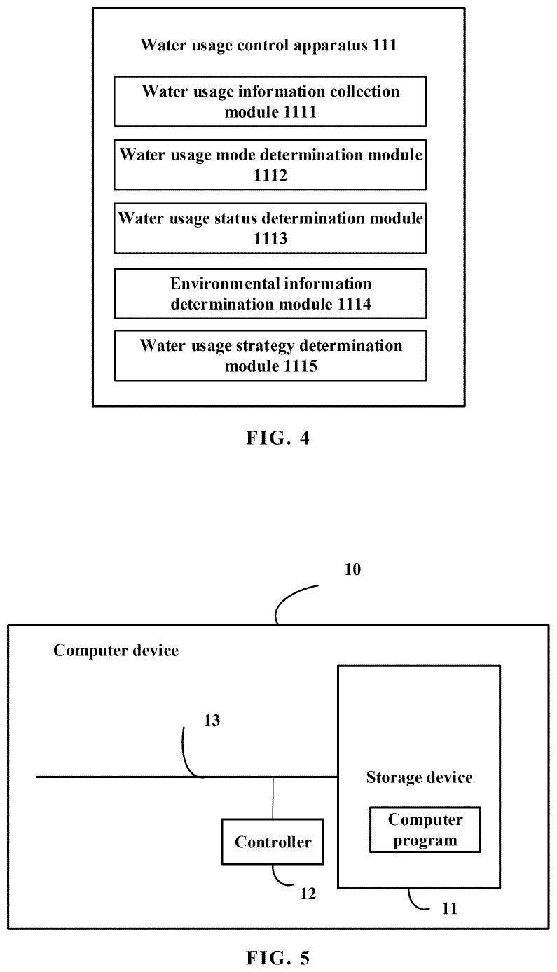

Please refer to FIG. 4, which is a structural diagram of a water usage control apparatus provided by an embodiment of the present application. In some embodiments, the water usage control apparatus 111 may include multiple functional modules composed of computer program segments. The computer programs of the various segments in the water usage control apparatus 111 may be stored in the memory of the computer device 10 and executed by at least one controller to perform the water usage control function (as described in detail in FIG. 2).

In this embodiment, the water usage control apparatus 111 is divided into multiple functional modules based on the functions it performs. The functional modules may include: a water usage information collection module 1111, a water usage mode determination module 1112, a water usage status determination module 1113, an environment information determination module 1114, and a water usage strategy determination module 1115. The modules referred to in this application are a series of computer program segments that can be executed by at least one controller and perform fixed functions, stored in the memory. In this embodiment, the functions of each module will be described in detail in subsequent embodiments.

The water usage information collection module 1111 is used to collect real-time water usage information corresponding to the target scenario.

The water usage mode determination module 1112 is used to determine the historical water usage mode corresponding to the target scenario.

The water usage status determination module 1113 is used to determine the water usage status corresponding to the target scenario based on the real-time water usage information and the historical water usage mode.

The environment information determination module 1114 is used to determine the target environment information corresponding to the target scenario when the water usage status is the abnormal water usage status.

The water usage strategy determination module 1115 is used to generate the water usage strategy corresponding to the target scenario based on the target environment information.

It can be understood that the water usage control apparatus 111 and the method for controlling water usage in the above embodiments belong to the same inventive concept. The specific implementation of each module in the water usage control apparatus 111 corresponds to the steps in the method for controlling water usage in the above embodiments, and will not be repeated here.

The division of modules described above is a logical function division. In actual implementation, there may be other division methods. In addition, the functional modules in each embodiment of this application may be integrated into the same processing unit, or each module may exist physically alone, or two or more modules may be integrated into the same unit. The integrated modules may be implemented in hardware or in hardware plus software functional modules.

FIG. 5 is a structural diagram of a computer device provided by an embodiment of the present application. As shown in FIG. 5, the computer device 10 includes a storage device 11, at least one controller 12, and at least one communication bus 13. The at least one controller 12 is used to execute a computer program stored in the storage device 11 to implement the method for controlling water usage. The at least one communication bus 13 is used to connect the storage device 11 and the at least one controller 12 for communication.

The structure of the computer device shown in FIG. 5 does not limit the embodiments of the present application. The computer device 10 may also include more or fewer other hardware or software components, or different component arrangements.

In some embodiments of the present application, the computer device 10 may also be connected to client devices. The client devices include, but are not limited to, any electronic product that can interact with users through a keyboard, a mouse, a remote control, a touchpad, or a voice control device, such as a personal computer, a tablet, a smartphone, a digital camera, etc.

It should be noted that the computer device 10 is only an example. Other existing or future electronic products that may be adapted to this application should also be included in the protection scope of this application and are incorporated herein by reference.

In some embodiments, the computer device 10 may also include various sensors, Bluetooth modules, Wi-Fi modules, etc., which will not be repeated here.

In some embodiments, the storage device 11 stores a computer program. When the computer program is executed by the at least one controller 12, it implements all or part of the steps of the method for controlling water usage. The storage device 11 includes read-only memory (ROM), programmable read-only memory (PROM), erasable programmable read-only memory (EPROM), one-time programmable read-only memory (OTPROM), electrically erasable programmable read-only memory (EEPROM), compact disc read-only memory (CD-ROM), or other optical disc storage, magnetic disk storage, magnetic tape storage, or any other medium that can be used to carry or store data.

In some embodiments, the computer-readable storage medium mainly includes a program storage area and a data storage area. The program storage area may store an operating system, applications required for at least one function, etc. The data storage area may store data created based on the use of the computer device 10.

In some embodiments, the at least one controller 12 is a control core of the computer device 10. It connects various components of the computer device 10 through various interfaces and lines, and executes the programs or modules stored in the storage device 11 and calls the data stored in the storage device 11 to perform various functions and process data of the computer device 10. For example, the at least one controller 12 executes the computer program stored in the memory to implement all or part of the steps of the method for controlling water usage in the embodiments of this application; or implements all or part of the functions of the product combination determination device. The at least one controller 12 may be composed of integrated circuits, such as a single packaged integrated circuit or multiple packaged integrated circuits with the same or different functions, including one or more central processing units (CPUs), microcontrollers, digital processing chips, graphics controllers, and various control chip combinations.

The above-mentioned integrated units implemented in the form of software functional modules may be stored in a computer-readable storage medium. The software functional modules stored in a storage medium include several instructions to instruct a computer device (which may be a personal computer, a computer device, or a network device, etc.) or a controller (processor) to execute some of the steps of the methods described in the embodiments of this application.

In the several embodiments provided in this application, it should be understood that the disclosed devices and methods may be implemented in other ways. For example, the device embodiments described above are only illustrative. For example, the division of modules is only a logical function division. In actual implementation, there may be other division methods.

The modules described as separate components may or may not be physically separated. The components displayed as modules may or may not be physical units. They may be located in one place or distributed across multiple network units. Some or all of the modules may be selected according to actual needs to achieve the objectives of the embodiments.

In addition, the functional modules in the various embodiments of this application may be integrated into one processing unit, or each module may exist physically alone, or two or more modules may be integrated into one unit. The above-mentioned integrated units may be implemented in hardware or in hardware plus software functional modules.

For those skilled in the art, it is clear that this application is not limited to the details of the above exemplary embodiments. Without departing from the spirit or essential characteristics of this application, this application can be implemented in other specific forms. Therefore, from any point of view, the embodiments should be regarded as illustrative and not restrictive. The scope of this application is defined by the appended claims rather than the above description. Therefore, it is intended to cover all changes that fall within the meaning and scope of the equivalent elements of the claims in this application. The reference signs in the claims should not be construed as limiting the claims. In addition, it is clear that the term “including” does not exclude other units or steps, and the singular does not exclude the plural. Multiple units or devices described in the specification may also be implemented by one unit or device through software or hardware. The terms “first,” “second,” etc., are used to indicate names and do not indicate any specific order.

Finally, it should be noted that the above embodiments are only used to illustrate the technical solutions of this application and are not intended to limit them. Although this application has been described in detail with reference to the preferred embodiments, those skilled in the art should understand that they can modify or equivalently replace the technical solutions of this application without departing from the spirit and scope of the technical solutions of this application.

What is claimed is:

1. A method for controlling water usage, comprising:
collecting real-time water usage information corresponding to a target scenario;
determining a historical water usage mode corresponding to the target scenario;
determining a water usage status corresponding to the target scenario based on real-time water usage information and the historical water usage mode;
determining target environment information corresponding to the target scenario in response that the water usage status is an abnormal water usage status; and
generating a water usage strategy corresponding to the target scenario based on the target environment information.

2. The method for controlling water usage according to claim 1, wherein collecting real-time water usage information corresponding to the target scenario comprises:
collecting water flow and water quality parameters of each of water pipes in the target scenario;
determining the water flow and the water quality parameters of each water pipe as the real-time water usage information.

3. The method for controlling water usage according to claim 1, wherein determining the historical water usage mode corresponding to the target scenario comprises:
obtaining historical water usage information corresponding to the target scenario;
determining fluctuation information and historical water quality information of water usage corresponding to the target scenario based on the historical water usage information; and
determining the historical water usage mode based on the fluctuation information and the historical water quality information.

4. The method for controlling water usage according to claim 1, wherein determining the water usage status corresponding to the target scenario based on the real-time water usage information and the historical water usage mode comprises:
determining the water usage status corresponding to the target scenario based on the real-time water usage information and the historical water usage mode using a preset detection model; or
determining outlier information in the real-time water usage information based on the real-time water usage information and the historical water usage mode, and determining the water usage status corresponding to the target scenario based on the outlier information; or
predicting a water usage based on the historical water usage mode using a preset water usage prediction mode; determining a water usage difference between the predicted water usage and a water usage corresponding to the real-time water usage information; and determining the water usage status corresponding to the target scenario based on the water usage difference.

5. The method for controlling water usage according to claim 1, wherein determining the target environment information corresponding to the target scenario comprises:
obtaining temperature information, humidity information, and rainfall information corresponding to the target scenario;
determining that the target environment information comprises the temperature information, the humidity information, and the rainfall information.

6. The method for controlling water usage according to claim 5, wherein determining the water usage strategy corresponding to the target scenario based on the target environment information comprises:
determining water usage time based on the temperature information;
determining a target water usage based on the humidity information and the rainfall information;
determining the water usage strategy based on the water usage time and the target water usage.

7. The method for controlling water usage according to claim 6, further comprising:
determining feedback information corresponding to the target scenario; and
determining an abnormal water source corresponding to the target scenario based on the feedback information and the real-time water usage information.

8. A computer device, comprising:
at least one controller;
a storage device, being stored with a computer program, which when executed by the at least one processor, cause the at least one processor to:
collect real-time water usage information corresponding to a target scenario;
determine a historical water usage mode corresponding to the target scenario;
determine a water usage status corresponding to the target scenario based on real-time water usage information and the historical water usage mode;
determine target environment information corresponding to the target scenario when the water usage status is an abnormal water usage status; and
generate a water usage strategy corresponding to the target scenario based on the target environment information.

9. The computer device according to claim 8, wherein collecting real-time water usage information corresponding to the target scenario comprises:
collecting water flow and water quality parameters of each of water pipes in the target scenario;
determining the water flow and the water quality parameters of each water pipe as the real-time water usage information.

10. The computer device according to claim 8, wherein determining the historical water usage mode corresponding to the target scenario comprises:
obtaining historical water usage information corresponding to the target scenario;
determining fluctuation information and historical water quality information of water usage corresponding to the target scenario based on the historical water usage information; and
determining the historical water usage mode based on the fluctuation information and the historical water quality information.

11. The computer device according to claim 8, wherein determining the water usage status corresponding to the target scenario based on the real-time water usage information and the historical water usage mode comprises:
determining the water usage status corresponding to the target scenario based on the real-time water usage information and the historical water usage mode using a preset detection model; or
determining outlier information in the real-time water usage information based on the real-time water usage information and the historical water usage mode, and determining the water usage status corresponding to the target scenario based on the outlier information; or
predicting a water usage based on the historical water usage mode using a preset water usage prediction mode; determining a water usage difference between the predicted water usage and a water usage corresponding to the real-time water usage information; and determining the water usage status corresponding to the target scenario based on the water usage difference.

12. The computer device according to claim 8, wherein determining the target environment information corresponding to the target scenario comprises:
obtaining temperature information, humidity information, and rainfall information corresponding to the target scenario;
determining that the target environment information comprises the temperature information, the humidity information, and the rainfall information.

13. The computer device according to claim 12, wherein determining the water usage strategy corresponding to the target scenario based on the target environment information comprises:
determining water usage time based on the temperature information;
determining a target water usage based on the humidity information and the rainfall information;
determining the water usage strategy based on the water usage time and the target water usage.

14. The computer device according to claim 13, further comprising:
determining feedback information corresponding to the target scenario; and
determining an abnormal water source corresponding to the target scenario based on the feedback information and the real-time water usage information.

15. A non-transitory storage medium, being stored with a computer program, which when executed by a controller of a computer device, a method for controlling water usage is implemented, wherein the method comprises:
collecting real-time water usage information corresponding to a target scenario;
determining a historical water usage mode corresponding to the target scenario;
determining a water usage status corresponding to the target scenario based on real-time water usage information and the historical water usage mode;
determining target environment information corresponding to the target scenario when the water usage status is an abnormal water usage status; and
generating a water usage strategy corresponding to the target scenario based on the target environment information.

16. The non-transitory storage medium according to claim 15, wherein collecting real-time water usage information corresponding to the target scenario comprises:
collecting water flow and water quality parameters of each of water pipes in the target scenario;
determining the water flow and the water quality parameters of each water pipe as the real-time water usage information.

17. The non-transitory storage medium according to claim 15, wherein determining the historical water usage mode corresponding to the target scenario comprises:
obtaining historical water usage information corresponding to the target scenario;
determining fluctuation information and historical water quality information of water usage corresponding to the target scenario based on the historical water usage information; and
determining the historical water usage mode based on the fluctuation information and the historical water quality information.

18. The non-transitory storage medium according to claim 15, wherein determining the water usage status corresponding to the target scenario based on the real-time water usage information and the historical water usage mode comprises:
determining the water usage status corresponding to the target scenario based on the real-time water usage information and the historical water usage mode using a preset detection model; or
determining outlier information in the real-time water usage information based on the real-time water usage information and the historical water usage mode, and determining the water usage status corresponding to the target scenario based on the outlier information; or
predicting a water usage based on the historical water usage mode using a preset water usage prediction mode; determining a water usage difference between the predicted water usage and a water usage corresponding to the real-time water usage information; and determining the water usage status corresponding to the target scenario based on the water usage difference.

19. The non-transitory storage medium according to claim 15, wherein determining the target environment information corresponding to the target scenario comprises:
obtaining temperature information, humidity information, and rainfall information corresponding to the target scenario;
determining that the target environment information comprises the temperature information, the humidity information, and the rainfall information.

20. The non-transitory storage medium according to claim 19, wherein determining the water usage strategy corresponding to the target scenario based on the target environment information comprises:
determining water usage time based on the temperature information;
determining a target water usage based on the humidity information and the rainfall information;
determining the water usage strategy based on the water usage time and the target water usage.
